(19) United States
(12) Patent Application Publication
(10) Pub. No.: US 2024/0154544 A1
(43) Pub. Date: May 9, 2024

(54) MAGNETIC SUSPENSION DEVICE

(71) Applicant: SRI LLC, Lewes, DE (US)

(72) Inventors: PHONG-NING JENG, Taichung City (TW); Edward Kuan Hsiung HSIEH, Torrance, CA (US); CHUN-HSIEN YANG, Changhua County (TW)

(21) Appl. No.: 18/279,541

(22) PCT Filed: May 20, 2021
(86) PCT No.: PCT/US2021/033455

§ 371 Date: Aug. 30, 2023

(51) Int. Cl. H02N 15/00

(52) U.S. Cl. CPC H02N 15/00

(57) ABSTRACT

A magnetic suspension device is provided, including: a base, including at least two first magnetic action units arranged in interval and corresponding to each other; and a suspension member, including at least two second magnetic action units, the at least two second magnetic action units magnetically interact with the at least two first magnetic action units so that the suspension member is suspended between the at least two first magnetic units.

### BACKGROUND OF THE INVENTION

### Field of the Invention

The present invention relates to a magnetic suspension device.

### Description of the Prior Art

An article is generally integrally assembled by plural components which are fixedly connected to each other and cannot be changed, so that the configuration of the article cannot be changed, and so that other functional components cannot be compatible with the article. As a result it is so dull and not functionally expandable.

A magnetic suspension device uses magnetic attraction or repulsion to suspend a part of the device. The conventional magnetic suspension device includes a base member and a suspension member. The base member is provided with an electromagnet, and the suspension member is provided with a permanent magnet. The electromagnet is energized to generate a magnetic field, and the magnetic field of the permanent magnet of the suspension member and the magnetic field generated by the electromagnet repel so that the suspension member suspends. However, the suspension member can be unstable and wobble easily because the magnetic field generated by the electromagnet is unstable and changes of environmental conditions (such as air flow, environmental electromagnetism, or the like). This problem can be more serious when the suspension member is non-spherical.

The present invention is, therefore, arisen to obviate or at least mitigate the above-mentioned disadvantages.

### SUMMARY OF THE INVENTION

The main object of the present invention is to provide a magnetic suspension device which is stable and not easy to deviate because of the magnetic force.

To achieve the above and other objects, a magnetic suspension device is provided, including: a base, including at least two first magnetic action units arranged in interval and corresponding to each other; and a suspension member, including at least two second magnetic action units, the at least two second magnetic action units magnetically interact with the at least two first magnetic action units so that the suspension member is suspended between the at least two first magnetic units.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a side view of a preferable embodiment of the present invention; and

FIGS. 4 and 5 are drawings showing another two preferable embodiments of the present invention.

### DETAILED DESCRIPTION OF THE PREFERRED EMBODIMENTS

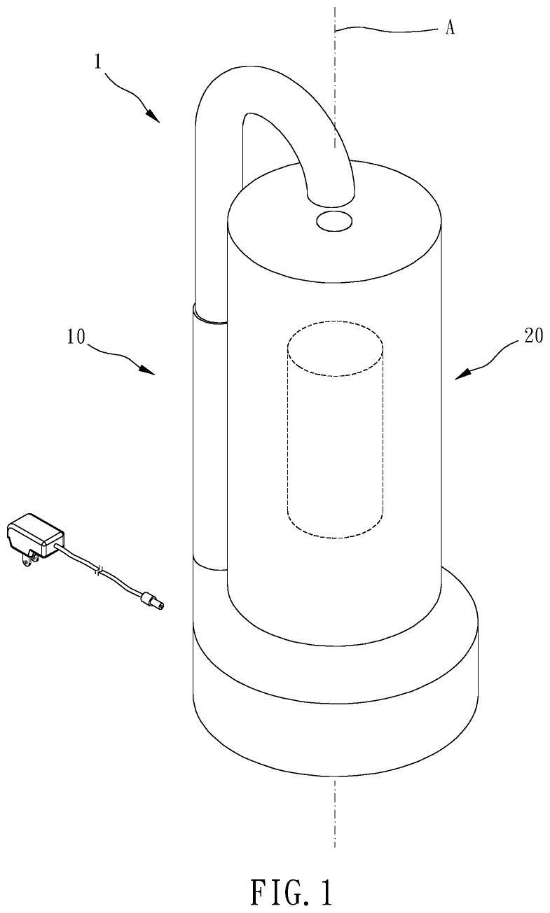

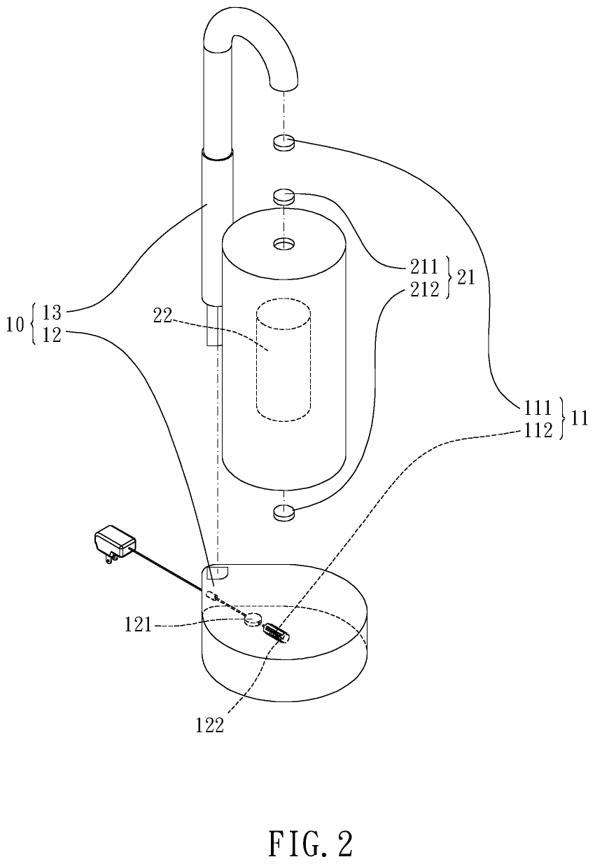

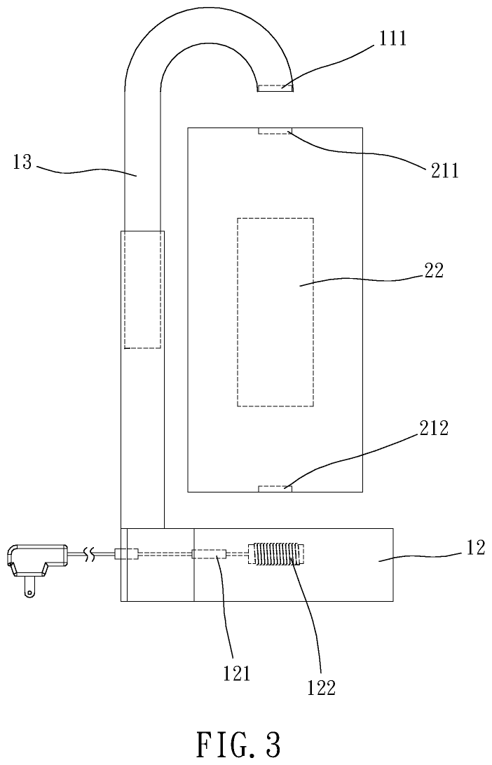

Please refer to FIGS. 1 to 3 for a preferable embodiment of the present invention. A magnetic suspension device 1 of the present invention includes a base 10 and a suspension member 20.

The base 10 includes at least two first magnetic action units 11 arranged in interval and corresponding to each other. The suspension member 20 includes at least two second magnetic action units 21, and the at least two second magnetic action units 21 magnetically interact with the at least two first magnetic action units 11 so that the suspension member 20 is suspended between the at least two first magnetic action units 11. Whereby, the magnetic force is applied on two opposite sides of the suspension member 20 so that the suspension member 20 is stable and not easy to deviate.

The base 10 includes a base member 12 and a frame member 13 which is connected to the base member 12 and extends away from the base member 12, and the at least two first magnetic action units 11 are respectively disposed on the base member 12 and the frame member 13. The at least two first magnetic action units 11 and the at least two second magnetic action units 21 define an axis A passing through a center of the suspension member 20. The suspension member 20 may be spherical or non-spherical, or regular or irregular shape. The suspension member 20 may be solid or hollow. In this embodiment, the suspension member 20 is non-spherical. Specifically, the suspension member 20 is an elongate body (cylindrical body, for example) extending along the axis A. The suspension member 20 is preferably hollow and includes two tubular members sleeved with each other so that object(s), such as photo(s), drawing(s) or the like, can be placed between the two tubular members for exhibition. To the elongate body, the center of gravity is located at the lower portion of the elongate body, so the upper portion of the elongate body is relatively unstable; however, the elongate body can be very stably suspended because of the magnetic force applied to two sides of the elongate body in a longitudinal direction of the elongate body. In an alternative embodiment, the elongate body can stably rotate about the axis A. By the magnetic interaction of the at least two first magnetic action units 11 and the at least two second magnetic action units 21, the suspension member 20 can rotate almost without frictional resistance and lasts for a very long time.

Specifically, the at least two first magnetic action units 11 includes at least one first upper magnetic action portion 111 and at least one first lower magnetic action portion 112 arranged in interval and corresponding to each other, the at least two second magnetic action units 21 includes at least one second upper magnetic action portion 211 and at least one second lower magnetic action portion 212, the at least one first upper magnetic action portion 111 and the at least one second upper magnetic action portion 211 attract, and the at least one first lower magnetic action portion 112 and the at least one second lower magnetic action portion 212 repel or attract (as long as the magnetic force is sufficient for suspending the suspension member 20). It is noted that the attraction of the at least two first magnetic action units 11 and the at least two second magnetic action units 21 can result in high stability of the suspension member 20.

In this embodiment, the at least one first upper magnetic action portion 111 includes at least one permanent magnet, and the at least one second upper magnetic action portion 211 includes at least one permanent magnet. The at least one first lower magnetic action portion 112 is disposed on the base member 12. The at least one first lower magnetic action portion 112 includes at least one electromagnet, and the at least one second lower magnetic action portion 212 includes at least one permanent magnet. The at least one permanent magnet and the at least one electromagnet may be exposed to the air or coated with non-magnetism shielding material. The base member 12 further includes at least one magnetism sensing member 121 (such as Hall sensor), and the at least one magnetism sensing member 121 is connected to coils 122 of the at least one electromagnet connected. A control circuit can be used to control the magnetic strength provided by the at least one electromagnet in according to changes of magnetic field detected by the at least one magnetism sensing member 121. As a result, the magnetic force applied to the suspension member 20 can be instantly adjusted, which stabilizes the suspension of the suspension member 20. The control circuit may be disposed inside the magnetic suspension device 1 or independently located outside the magnetic suspension device 1; and the control circuit may wirely or wirelessly control the at least one electromagnet. Preferably, the frame member 13 is detachably assembled with the base member 12 (by insertion, screwing, buckling, or the like), thus being convenient for assembling/disassembling, storage. Preferably, a distance between the at least two first magnetic action units 11 is adjustable. For example, the length of the frame member 13 is adjustable (retractable, multi-sectioned, flexible, or in other adjustable mechanism), which provides easy and quick adjustment for distance and magnetic force between the at least one first upper magnetic action portion 111 and the at least one second upper magnetic action portion 211 according to weight, size and position of the suspension member 20.

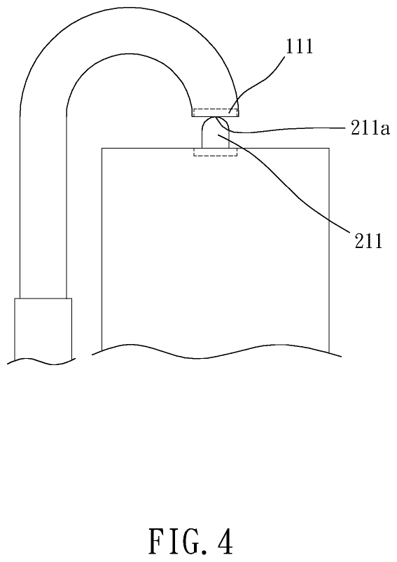

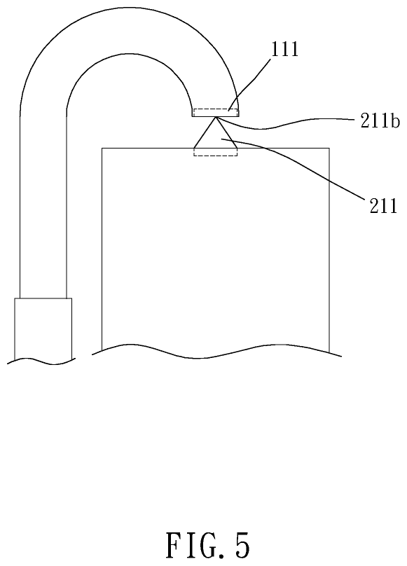

In this embodiment, the at least one first upper magnetic action portion 111 and the at least one second upper magnetic action portion 211 are arranged in interval, and thus the suspension member 20 can rotate without frictional resistance. In an embodiment shown in FIGS. 4 and 5, one of the at least one first upper magnetic action portion 111 and the at least one second upper magnetic action portion 211 includes an arcuate face 211a or tip 211b, and the at least one first upper magnetic action portion 111 and the at least one second upper magnetic action portion 211 are substantially in point contact via the arcuate face 211a or tip 211b, wherein the frictional resistance is extremely small and can be omitted. The suspension member may be shaped in a configuration matching with the shape of the tip. For example, the suspension member may be configured in a Christmas tree, triangular pyramid or the like, and the tip is provided on the apex of the suspension member.

The suspension member 20 further at least one includes at least one electronic component 22, and the at least one electronic component 22 is capable of providing at least one of electrical signal, optical signal, audio signal or/and vibration signal, to provide functional applications, information, reminder or/and warming, and so on. For example, the electronic component 22 may include a transceiver which is communicable with external devices (such as mobile phone, computer, etc.), which can provide information such as time information or any requirement information; the electronic component 22 may include a light-emitting element for providing light; the electronic component 22 may include a speaker (such as bluetooth speaker) for providing sound; the electronic component 22 may include a vibrator for providing vibration.

In other embodiment, the suspension member may further include a battery and a charging module, to supply electricity to the electronic component, wherein the charging module may be wired or wireless type. The base member may include a wireless charging module, wherein the battery can be charged by the charging module of the suspension member; the magnetic suspension device may further include a photoelectric conversion module (such as solar panels), to supply electricity to the magnetic suspension device (may further to the electromagnet). The photoelectric conversion module may be arranged at any position of at least one of the base and the suspension member, or arranged outside and connected to the magnetic suspension device; the magnetic suspension device may further include at least one electric connection port of Universal Serial Bus (USB), power, data transmission, for example, for electrical connection, setting, controlling or/and data transmitting of the magnetic suspension device with the external device(s).

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A magnetic suspension device, including:
a base, including at least two first magnetic action units arranged in interval and corresponding to each other; and
a suspension member, including at least two second magnetic action units, the at least two second magnetic action units magnetically interact with the at least two first magnetic action units so that the suspension member is suspended between the at least two first magnetic units.

2. The magnetic suspension device of claim 1, wherein the base includes a base member and a frame member which is connected to the base member and extends away from the base member, and the at least two first magnetic action units are respectively disposed on the base member and the frame member.

3. The magnetic suspension device of claim 1, wherein the at least two first magnetic action units and the at least two second magnetic action units define an axis passing through a center of the suspension member.

4. The magnetic suspension device of claim 1, wherein the suspension member is spherical or non-spherical, or regular or irregular shape.

5. The magnetic suspension device of claim 1, wherein the at least two first magnetic action units include at least one first upper magnetic action portion and at least one first lower magnetic action portion arranged in interval and corresponding to each other, the at least two second magnetic action units include at least one second upper magnetic action portion and at least one second lower magnetic action portion, the at least one first upper magnetic action portion and the at least one second upper magnetic action portion attract, and the at least one first lower magnetic action portion and the at least one second lower magnetic action portion repel or attract.

6. The magnetic suspension device of claim 5, wherein one of the at least one first upper magnetic action portion and the at least one second upper magnetic action portion includes an arcuate face or tip, and the at least one first upper magnetic action portion and the at least one second upper magnetic action portion are substantially in point contact via the arcuate face or tip.

7. The magnetic suspension device of claim 5, wherein the at least one first upper magnetic action portion and the at least one second upper magnetic action portion are arranged in interval.

8. The magnetic suspension device of claim 7, wherein the base includes a base member and a frame member which is connected to the base member and extends away from the base member, and the at least two first magnetic action units are respectively disposed on the base member and the frame member; the at least one first upper magnetic action portion includes at least one permanent magnet, the at least one second upper magnetic action portion includes at least one permanent magnet, the at least one first lower magnetic action portion is disposed on the base member, the at least one first lower magnetic action portion includes at least one electromagnet, and the at least one second lower magnetic action portion includes at least one permanent magnet; the frame member is detachably assembled with the base member, and the frame member has an adjustable length; the base member further includes at least one magnetism sensing member, and the at least one magnetism sensing member is connected to and coils of the at least one electromagnet; the at least two first magnetic action units and the at least two second magnetic action units define an axis passing through a center of the suspension member; and the suspension member is spherical or non-spherical, or regular or irregular shape.

9. The magnetic suspension device of claim 1, wherein a distance between the at least two first magnetic action units is adjustable.

10. The magnetic suspension device of claim 1, wherein the suspension member further includes at least one electronic component, and the at least one electronic component is capable of providing at least one of electrical signal, optical signal, audio signal or/and vibration signal.
